(19) United States
(12) Patent Application Publication
(10) Pub. No.: US 2025/0308735 A1
(43) Pub. Date: Oct. 2, 2025

(54) SOFT MAGNETIC ALLOY

(71) Applicant: DAIDO STEEL CO., LTD., Nagoya-shi (JP)

(72) Inventors: Hiroyuki TAKABAYASHI, Nagoya-shi (JP); Yuya TOMITA, Nagoya-shi (JP); Chihiro FURUSHO, Nagoya-shi (JP)

(21) Appl. No.: 19/090,065

(22) Filed: Mar. 25, 2025

(30) Foreign Application Priority Data
Mar. 27, 2024 (JP) 2024-051697

(51) Int. Cl. H01F 1/147; C22C 38/00; C22C 38/02; C22C 38/04; C22C 38/06; C22C 38/10; C22C 38/12; C22C 38/16; C22C 38/20; C22C 38/22; C22C 38/26; C22C 38/30; C22C 38/32; C22C 38/34; C22C 38/42; C22C 38/44; C22C 38/48; C22C 38/54; C22C 45/02

(52) U.S. Cl. CPC H01F 1/14708; C22C 38/001; C22C 38/002; C22C 38/004; C22C 38/02; C22C 38/04; C22C 38/06; C22C 38/10; C22C 38/12; C22C 38/16; C22C 38/20; C22C 38/22; C22C 38/26; C22C 38/30; C22C 38/32; C22C 38/34; C22C 38/42; C22C 38/44; C22C 38/48; C22C 38/54; C22C 45/02; C22C 2200/02; C22C 2200/04; C22C 2202/02

(57) ABSTRACT

The present invention relates to a soft magnetic alloy including, in terms of at %: 0.9%<M≤10%, M being at least one element selected from the group consisting of Cr, Mn, Ni, and Co; 7.0%≤Si≤20%; 5.0%≤B≤10%; 2.5%≤Nb≤5.0%; 0.5%≤Cu≤2.0%, with the balance being Fe and unavoidable impurities, in which the soft magnetic alloy satisfies −3.0%<(2[Co]+1[Ni])−(1[Cr]+2[Mn])<3.0%, in which [Co], [Ni], [Cr], and [Mn] respectively represents contents of Co, Ni, Cr, and Mn.

### CROSS-REFERENCE TO RELATED APPLICATIONS

This application is based on and claims priority under 35 USC 119 from Japanese Patent Application No. 2024-051697 filed on Mar. 27, 2024, the entire content of which is incorporated herein by reference.

### TECHNICAL FIELD

The present invention relates to a soft magnetic alloy, and more particularly to a soft magnetic alloy includes a Fe—Si—B—Nb—Cu alloy.

### BACKGROUND ART

A Fe—Si—B—Nb—Cu alloy is known as one kind of soft magnetic alloys used for high-frequency transformers and choke coils. The Fe—Si—B—Nb—Cu alloy is disclosed in the following Patent Literatures 1 to 3. The Fe—Si—B—Nb—Cu alloy is obtained as an amorphous material, and heated to obtain a structure containing nanocrystals. With the generation of nanocrystals, good soft magnetic properties can be obtained. Further, it is known that Cu and Nb, and elements such as V, Ti, W, Hf, and Ta can make the obtained nanocrystals fine in the alloy. In addition, the addition of Si increases magnetic permeability. In this way, components are adjusted so as to obtain desired properties for the Fe—Si—B—Nb—Cu alloy.

Patent Literature 1: JP2019-148004A

Patent Literature 2: JP2016-211067A

Patent Literature 3: JP2009-263775A

### SUMMARY OF INVENTION

In addition to having high magnetic properties such as a high saturation magnetic flux density and good soft magnetic properties, the Fe—Si—B—Nb—Cu alloy also has a high electrical resistance, which is an important property, from the viewpoint of reducing eddy current loss at high frequency. In particular, in the case where the Fe—Si—B—Nb—Cu alloy is used for a high-frequency transformer or a choke coil, it is desirable to achieve both a high saturation magnetic flux density and a high electrical resistance from the viewpoint of size reduction. In order to increase the electrical resistance of the Fe—Si—B—Nb—Cu alloy, it is conceivable to add a high-resistance element such as Cr, Mn, Ni, and Co. As the contents of these elements are increased, the electrical resistance can be improved. However, when these elements are added in a large amount, the magnetic properties of the alloy are likely to decrease. In particular, a reduction in the Fe content tends to cause a decrease in the saturation magnetic flux density. In this way, in the Fe—Si—B—Nb—Cu alloy, it is difficult to achieve both a high saturation magnetic flux density and a high electrical resistance.

An object of the present invention is to provide a soft magnetic alloy capable of achieving both a high saturation magnetic flux density and a high electrical resistance in a Fe—Si—B—Nb—Cu alloy.

In order to achieve the above object, a soft magnetic alloy according to the present invention has the following configuration.
[1] A soft magnetic alloy including, in terms of at %:
0.9%<M≤10%, M being at least one element selected from the group consisting of Cr, Mn, Ni, and Co;

$$7. \% \leq Si \leq 20 \% ;$$

$$5. \% \leq B \leq 10 \% ;$$

$$2.5 \% \leq N b \leq 5. \% ;$$

$$0.5 \% \leq Cu \leq 2. \% ,$$

with the balance being Fe and unavoidable impurities,
wherein the soft magnetic alloy satisfies −3.0%<(2 [Co]+1 [Ni])−(1 [Cr]+2 [Mn])<3.0%, in which [Co], [Ni], [Cr], and [Mn] respectively represents contents of Co, Ni, Cr, and Mn.
[2] The soft magnetic alloy according to the above [1], further including, in terms of at %:
at least one of 0%<P≤2.0% or 0%<S≤0.15%.
[3] The soft magnetic alloy according to the above [1] or [2], in which the soft magnetic alloy is in a form of an amorphous alloy ribbon.
[4] The soft magnetic alloy according to the above [3], which is configured to generate nanocrystals having an average grain size of 30 nm or less through a heat treatment at 570° C. for 30 minutes.
[5] The soft magnetic alloy according to the above [1] or [2], in which the soft magnetic alloy is in a form of an alloy ribbon containing nanocrystals.
[6] The soft magnetic alloy according to the above [5], in which the nanocrystals have an average grain size of 30 nm or less.

The soft magnetic alloy according to the present invention having the configuration of [1] above has a high electrical resistance by containing at least one selected from the group consisting of Cr, Mn, Ni, and Co in a sufficient amount as the element M. When each of Cr, Mn, Ni, and Co is added, Fe is substituted with each of the element in the soft magnetic alloy. The addition amount of each of the element is set so as to satisfy the relationship of −3.0% <(2 [Co]+1 [Ni])−(1 [Cr]+2 [Mn])<3.0%, so that the number of valence electrons of the material as a whole becomes close to the number of valence electrons in the state where Fe is not substituted with these elements. Therefore, excellent magnetic properties such as a high saturation magnetic flux density of Fe are less likely to be impaired by the addition of the element M. In this way, the soft magnetic alloy according to the present invention achieves both a high saturation magnetic flux density and a high electrical resistance in a balanced manner.

In addition, when the element M is not excessively added to the soft magnetic alloy, a sufficient amount of Cu or Nb that has an effect on refinement of nanocrystals formed through the heat treatment can be added. As a result, it is possible to stably generate fine nanocrystal grains with high robustness against variations in production conditions such as a temperature rise rate, a heating time, and the like during the heat treatment, and to improve stability in terms of properties of the soft magnetic alloy.

In the aspect of [2] above, at least one of P or S is added to the soft magnetic alloy. P exhibits an effect of preventing the coarsening of the nanocrystal grains by coexisting with Cu. S exhibits an effect of improving workability such as punchability in the soft magnetic alloy.

In the aspect of [3] above, the soft magnetic alloy is in the form of an amorphous alloy ribbon, and nanocrystals are formed through the heat treatment. In the aspect of [5] above, the soft magnetic alloy is already a nanocrystal alloy containing nanocrystals. When the soft magnetic alloy has the above component composition, the soft magnetic alloy is in an amorphous state without being subjected to the heat treatment, and the amorphous alloy is further subjected to the heat treatment to obtain a nanocrystal alloy containing nanocrystal grains. The nanocrystal alloy exhibits high soft magnetic properties.

In particular, as in the aspects of [4] and [6] above, when the formed nanocrystals have an average grain size of 30 nm or less, a high effect of improving the soft magnetic properties can be obtained. When the soft magnetic alloy has the above component composition, it is possible to obtain a nanocrystal alloy in which the average grain size of the nanocrystal grains is reduced to 30 nm or less with high robustness against the production conditions.

### DESCRIPTION OF EMBODIMENTS

Hereinafter, a soft magnetic alloy according to an embodiment of the present invention will be described in detail. The soft magnetic alloy according to the present embodiment has a predetermined component composition. In the present description, a content of each element is expressed in terms of at %. In addition, the various properties indicate values in the atmosphere at room temperature.

### Component Composition of Soft Magnetic Alloy

The soft magnetic alloy according to the embodiment of the present invention contains an element M, Si, B, Nb, and Cu in the following predetermined amounts, with the balance being unavoidable impurities and Fe. Here, the element M refers to at least one element selected from the group consisting of Cr, Mn, Ni, and Co.

$$0.9 \% \leq M \leq 10 \%$$

The soft magnetic alloy according to the present embodiment contains the element M, that is, at least one selected from the group consisting of Cr, Mn, Ni, and Co, and a total content thereof is 0.9%<M≤10%. Each of Cr, Mn, Ni, and Co improves the electrical resistance of the soft magnetic alloy. When the content of the element M is set to 0.9%<M, the effect of improving the electrical resistance is sufficiently obtained. It is more preferable that 0.95%<M, further preferable that 1.5%<M, and still further preferable that 2.5%<M.

However, when the element M is excessively added to the soft magnetic alloy, the magnetic permeability of the soft magnetic alloy decreases. From the viewpoint of preventing a decrease in magnetic permeability, the content of the element M is set to M≤10%. In addition, when the content of the element M is reduced to 10% or less, as will be described below, it is easy to add a sufficient amount of Cu or Nb having an effect of refining nanocrystals. Thus, the robustness of the nanocrystal grain generation against the production conditions is increased. That is, even when the production conditions such as the temperature rise rate and the heating time during the heat treatment vary, fine nanocrystal grains can be stably generated. As a result, high magnetic properties can be stably obtained in the soft magnetic alloy. It is more preferable that M≤8.0%, and further preferable that M≤6.0%.

A total content of Cr, Mn, Ni, and Co satisfies the above range, and a relationship between the individual contents satisfies the following formula (1). Accordingly, the soft magnetic alloy has high saturation magnetic flux density.

$$- 3. \% < ( 2 [ Co ] + 1 [ Ni ] ) - ( 1 [ Cr ] + 2 [ Mn ] ) < 3. \% \qquad ( 1 )$$

In the formula (1), [Co], [Ni], [Cr], and [Mn] represent contents of Co, Ni, Cr, and Mn, respectively, in terms of at %.

When each of Cr, Mn, Ni, and Co is added, Fe is substituted with each of these elements in the soft magnetic alloy. Here, A=(2 [Co]+1 [Ni])−(1 [Cr]+2 [Mn]) which is a parameter handled in the above formula (1) is an index indicating how far the number of valence electrons in the soft magnetic alloy is away from the number of valence electrons in an unsubstituted state. Here, the unsubstituted state refers to a state where Fe is not substituted 10 with Cr, Mn, Ni, or Co, that is, a state where the total content of Cr, Mn, Ni, and Co in the soft magnetic alloy is zero and the content of Fe corresponding to the content of Cr, Mn, Ni, and Co is further contained. As the value of |A| is increased, the gap in the number of valence electrons from the unsubstituted state is increased. Here, the number of valence electrons of Cr, Mn, Ni, and Co are as shown below, respectively. A difference of the number of valence electrons with Fe, the number of valence electrons of which is 8, is also shown in parentheses.

$$Cr : 6 ( - 2 ) , Mn : 7 ( - 1 ) , Ni : 10 ( + 2 ) , Co : 9 ( + 1 )$$

That is, the addition of Cr and Mn acts in the direction of decreasing the number of valence electrons from the unsubstituted state, and Ni and Co act in the direction of increasing the number of valence electrons from the unsubstituted state. In addition, Mn and Co do not 20 exhibit the same effect in increasing or decreasing the number of valence electrons as Cr and Ni, unless they are added in amounts twice as large as each other in terms of the number of atoms. Therefore, the above A value functions as an index indicating how far the number of valence electrons is away from the unsubstituted state.

The above formula (1) defines that |A|<3.0%. That is, it is ensured that the number of valence electrons in the soft magnetic alloy is not greatly away from that in the unsubstituted state. This means that, in the soft magnetic alloy, the magnetic properties to which the valence electrons contribute, including the saturation magnetic flux density (Bs), are not greatly changed by the addition of Cr, Mn, Ni, and Co, and the excellent magnetic properties of Fe are less likely to be impaired. As the value of |A| is reduced, the effect of keeping the saturation magnetic flux density high is excellent. It is more preferable that |A|<2.5%, further preferable that |A|<2.0%, and still further preferable that |A|<1.0%.

In the soft magnetic alloy according to the present embodiment, the addition contents of Cr, Mn, Ni, and Co are in the range of 0.9%<M ≤10% in total, and the individual contents satisfy the relationship of the formula (1), so that both a high electrical resistance and a high saturation magnetic flux density are achieved in a balanced manner. As long as the total content and the relationship between the individual contents thereof satisfy the above ranges, the presence or absence and the content of the individual elements including Cr, Mn, Ni, and Co are not particularly limited. However, it is preferable to contain at least two selected from the group consisting of Cr, Mn, Ni, and Co from the viewpoint of satisfying the formula (1) with a margin. In particular, it is preferable to contain at least one of Cr or Mn and at least one of Ni or Co.

$$7. \% \leq Si \leq 20 \%$$

Si exhibits effects such as improvement in magnetic permeability, reduction in magnetostriction, and reduction in eddy current loss in a soft magnetic alloy. When the content of Si is set to 7.0%≤Si, these effects can be sufficiently obtained. It is preferable that 10%≤Si, and more preferable that 15%≤Si.

On the other hand, when Si is contained in a too large amount, the content of Fe in the soft magnetic alloy is relatively decreased. This leads to deterioration in magnetic properties, such as making it difficult to obtain sufficiently high saturation magnetic flux density. From the viewpoint of preventing deterioration in magnetic properties, the content of Si is set to Si≤20%. It is preferable that Si≤18%.

$$5. \% \leq B \leq 10 \%$$

B exhibits an effect of amorphization of the soft magnetic alloy. Nanocrystals can be generated by subjecting the amorphous soft magnetic alloy to heat treatment. From the viewpoint of sufficiently promoting the amorphization of the soft magnetic alloy, the content of B is set to 5.0%≤B. It is preferable that 6.0%≤B, and more preferable that 7.0%≤B.

On the other hand, when a large amount of B is contained in the soft magnetic alloy, a FeB compound is likely to be formed when the amorphous alloy is subjected to heat treatment to form a nanocrystal alloy. The FeB compound causes the magnetic properties of the soft magnetic alloy to decrease. From the viewpoint of preventing the generation of the FeB compound, the content of B is set to B≤10%. It is preferable that B≤9.0%.

$$2.5 \% \leq N b \leq 5. \%$$

Nb has an effect of preventing coarsening of crystal grains and facilitating generation of fine nanocrystals in the soft magnetic alloy. From the viewpoint of sufficiently obtaining the effect, the content of Nb is set to 2.5%≤Nb. It is preferable that 2.8%≤Nb, and more preferable that 3.0%≤Nb.

However, when Nb is added in a too large amount, the content of Fe in the soft magnetic alloy is relatively decreased. This leads to deterioration in magnetic properties, such as making it difficult to obtain sufficiently high saturation magnetic flux density. From the viewpoint of preventing deterioration in magnetic properties, the content of Nb is set to Nb≤5.0%. When the Nb is contained in an amount of 5.0% or less, a sufficiently high effect of preventing coarsening of crystal grains can be obtained. It is preferable that Nb ≤4.5%.

$$0.5 \% \leq Cu \leq 2. \%$$

Cu promotes formation of clusters serving as nuclei constituting nanocrystals in the soft magnetic alloy through heat treatment. From the viewpoint of obtaining a sufficient effect of promoting cluster formation, the content of Cu is set to 0.5%≤Cu. It is preferable that 0.8%≤Cu, and more preferable that 1.0%≤Cu.

However, when Cu is excessively added, clusters are coarsened, and the refinement of a crystal containing Fe is rather inhibited. From the viewpoint of preventing this, the content of Cu is set to Cu≤2.0%. It is preferable that Cu≤1.5%, and more preferable that Cu≤1.2%.

The soft magnetic alloy according to the present embodiment may contain only at least one selected from the group consisting of Cr, Mn, Ni, and Co in the above predetermined amount and Si, B, Nb, and Cu as essential elements. Further, as an optional element, at least one of P, S, C, or Mo may be contained in a predetermined amount as shown below. In particular, an embodiment containing at least one of P or S is preferable.

$$0 \% < P \leq 2. \%$$

P has an effect of preventing coarsening of clusters formed by Cu by coexisting with Cu in the soft magnetic alloy. P exhibits an effect of preventing the coarsening of clusters even when added in a small amount, and therefore, there is no particular lower limit for the content of P. However, when the content is more preferably set to 0.01%≤P and further preferably set to 0.05%≤P, a high addition effect is obtained. Note that P in an amount of less than 0.01% can be regarded as unavoidable impurities.

On the other hand, addition of P in a large amount leads to a decrease in the magnetic properties of the soft magnetic alloy. From the viewpoint of maintaining high magnetic properties, the content of P is preferably set to P≤2.0%.

$$0 \% < S \leq 0.15 \%$$

S improves workability such as punchability when being added to a soft magnetic alloy. S exhibits an effect of improving the workability even when added in a small amount, and therefore, there is no particular lower limit for the content of S. However, when the content of S is more preferably set to 0.01%≤S and further preferably set to 0.05%≤S, a high addition effect is obtained. Note that S in an amount of less than 0.01% can be regarded as unavoidable impurities.

On the other hand, the addition of S in a large amount leads to a decrease in the magnetic properties of the soft magnetic alloy. From the viewpoint of maintaining high magnetic properties, the content of S is preferably set to S≤0.15%. It is more preferable that S≤0.10%.

$$0 \% < C \leq 0.3 \%$$

C also improves workability such as punchability when being added to a soft magnetic alloy. C exhibits an effect of improving the workability even when added in a small amount, and therefore, there is no particular lower limit for the content of C. However, when the content of C is more preferably set to 0.01%≤C and further preferably set to 0.05%≤C, a high addition effect is obtained. Note that C in an amount of less than 0.01% can be regarded as unavoidable impurities.

On the other hand, the addition of C in a large amount leads to a decrease in the magnetic properties of the soft magnetic alloy. From the viewpoint of maintaining high magnetic properties, the content of C is preferably set to C≤0.30%.

$$0 \% < Mo \leq 3. \%$$

Mo contributes to improvement in corrosion resistance when added to the soft magnetic alloy. Mo exhibits an effect of improving corrosion resistance even when added in a small amount, and therefore, there is no particular lower limit for the content of Mo. However, when the content of Mo is more preferably set to 0.01%≤Mo and further preferably set to 0.05%≤Mo, a high addition effect is obtained. Note that Mo in an amount of less than 0.01% can be regarded as unavoidable impurities.

On the other hand, when Mo is added in a large amount, the content of Fe in the soft magnetic alloy is relatively decreased. This leads to deterioration in magnetic properties, such as making it difficult to obtain sufficiently high saturation magnetic flux density. From the viewpoint of preventing deterioration in the magnetic properties, the content of Mo is preferably set to Mo≤3.0%.

As described above, the soft magnetic alloy according to the present embodiment contains at least one selected from the group consisting of Cr, Mn, Ni, and Co in the above predetermined amount, Si, B, Nb, and Cu, with the balance being unavoidable impurities and Fe. The soft magnetic alloy may further contain at least one of P, S, C, or Mo in the above predetermined amount as an optional element. The unavoidable impurities are allowed to be contained in a range in which the properties of the soft magnetic alloy such as magnetic properties are not greatly impaired. Specific examples of the unavoidable impurities include Al<0.50%, O<0.05%, N<0.05%, and Mg and Ca of 0.05% or less in total. By allowing the inclusion of impurities within the above content range, it is possible to avoid an increase in production cost due to excessive elimination of the inclusion of impurities in the production of the soft magnetic alloy. Since O has an effect of reducing eddy current loss, O may be contained in the soft magnetic alloy in the range of O<0.05%.

A shape of the soft magnetic alloy according to the present embodiment is not particularly limited and may be any shape. However, it is preferable to take the form of an alloy ribbon. The alloy ribbon may be made of an amorphous alloy or a nanocrystal alloy containing nanocrystals.

### Method for Producing Soft Magnetic Alloy

Here, as an example of a method for producing a soft magnetic alloy according to the present embodiment, a method for producing a soft magnetic alloy as an alloy ribbon will be briefly described.

The soft magnetic alloy in a ribbon shape can be produced by a single-roll liquid quenching method. That is, an alloy ribbon can be obtained by ejecting a molten alloy having a predetermined component composition onto a surface of a copper roll rotating at high speed, and rapidly cooling and solidifying the molten alloy. The alloy ribbon is preferably produced in an inert atmosphere such as an Ar atmosphere. Examples of the production conditions include conditions in which a circumferential speed of a roll is set to 10 m/s to 50 m/s, a differential pressure between a melting chamber for preparing the molten alloy and a quenching chamber for disposing a copper roll is set to 20 kPa to 80 kPa, and a gap between a nozzle for ejecting the molten alloy and the roll is set to 0.2 mm to 0.5 mm. The thickness of the obtained alloy ribbon is about 10 μm to 50 μm.

As described above, the ribbon-shaped soft magnetic alloy obtained by quenching the molten alloy is amorphous. A nanocrystal alloy can be obtained by subjecting the amorphous alloy ribbon to heat treatment. The nanocrystal alloy contains nanocrystals in an amorphous matrix. The heat treatment is preferably performed in an inert atmosphere such as an Ar atmosphere. Examples of the heat treatment conditions include conditions in which a heat treatment temperature is set to 450° C. to 570° C. and a holding time at a predetermined heat treatment temperature is set to 10 minutes to 120 minutes. The temperature rise rate from room temperature to the heat treatment temperature may be, for example, 1.0° C./s to 5.0° C./s. After the heat treatment, natural cooling may be performed in an inert gas.

### Properties of Soft Magnetic Alloy

When the soft magnetic alloy according to the present embodiment has the above component composition, the soft magnetic alloy has excellent soft magnetic properties such as high magnetic permeability and high saturation magnetic flux density. The soft magnetic alloy has high electrical resistance in addition to these magnetic properties. In particular, when the element M which is a high-resistance element, that is, at least one selected from the group consisting of Co, Ni, Cr, and Mn is contained in sufficient amounts, a high effect of increasing the electrical resistance is obtained. Additionally, the total amount of the element M is reduced to be equal to or less than the predetermined upper limit, the content of each element satisfies the relationship represented by the formula (1), and the number of valence electrons does not greatly change from a state where Fe is not substituted with the element M, so that a high saturation magnetic flux density is obtained. In this way, the soft magnetic alloy according to the present embodiment achieves both a high saturation magnetic flux density and a high electrical resistance in a balanced manner.

When the soft magnetic alloy according to the present embodiment contains B having a high effect on formation of the amorphous structure and Nb and Cu having a high effect on prevention of coarsening of crystal grains in sufficient amounts, the amorphous alloy can be easily obtained in a state before the heat treatment, and by further subjecting the amorphous alloy to the heat treatment, a nanocrystal alloy containing fine nanocrystals can be obtained. In addition, fine nanocrystals can be generated with high robustness against the production conditions. That is, even if the production conditions of the soft magnetic alloy vary, including the temperature rise rate and the heat treatment time during the heat treatment, the nanocrystal alloy containing fine nanocrystals can be produced. Thus, the production conditions can be easily controlled, and the properties of the soft magnetic alloy to be produced are also stabilized.

The nanocrystal alloy obtained through the heat treatment contains nanocrystal grains having a body-centered cubic structure in the amorphous matrix. It is preferable that FeB equal to or larger than the X-ray diffraction detection limit is not contained in the nanocrystal alloy. An average grain size of the nanocrystals in the nanocrystal alloy obtained through the heat treatment is preferably 30 nm or less, more preferably 20 nm or less, and still more preferably 15 nm or less. For example, in the case where an amorphous alloy is subjected to heat treatment at 570° C. for 30 minutes, the nanocrystals having above crystal grain size may be contained.

As described above, the soft magnetic alloy according to the present embodiment is configured to have a high saturation magnetic flux density and a high electrical resistance, and for example, the saturation magnetic flux density is preferably 1.1 T or more, and more preferably 1.2 T or more. The electrical resistivity is preferably 107 μm or more, and more preferably 120 μm or more. The saturation magnetic flux density and the electrical resistivity are measured in a state of a nanocrystal alloy obtained by subjecting the amorphous alloy to heat treatment. Examples of the heat treatment conditions at this time include heat treatment at 570° C. for 30 minutes.

### EXAMPLES

Hereinafter, the present invention will be described more specifically with reference to Examples. The present invention is not limited by these Examples.

### Preparation of Samples

As soft magnetic alloys according to Examples 1 to 22 and Comparative Examples 1 to 10, alloy ribbons containing the component elements at concentrations shown in Table 1, with the balance being unavoidable impurities and Fe, were prepared. In this case, molten alloys having a predetermined component composition ratio were prepared, and ribbons were produced according to a single-roll liquid quenching method. That is, the molten alloy was ejected from a melting chamber to a surface of a copper roll rotating in a quenching chamber, and quenched and solidified. The atmosphere during production was an Ar atmosphere, and a quartz nozzle was used to eject the molten alloy. As production conditions, a circumferential speed of a roll was set to 10 m/s to 50 m/s, a differential pressure between the melting chamber and the quenching chamber was set to 20 kPa to 80 kPa, and a gap between the nozzle and the roll was 0.2 mm to 0.5 mm. The thickness of the obtained alloy ribbon was 18 μm to 20 μm.

Further, the alloy ribbon produced according to the single-roll liquid quenching method was subjected to the heat treatment. In the heat treatment, the alloy ribbon was heated from room temperature to 570° C. ±5° C. at a temperature rise rate of 5° C./min in a heating furnace under an Ar atmosphere. Then, the alloy ribbon was held at the heat treatment temperature of 570° C. ±5° C. for 30 minutes. Thereafter, the heating was stopped, and the alloy ribbon was naturally cooled in the heating furnace. Regarding samples for evaluating the saturation magnetic flux density, the alloy ribbon produced according to the single-roll liquid quenching method described above was processed into a toroidal wound core having an outer diameter of 22 mm and an inner diameter of 20 mm, and then the heat treatment was performed under the above conditions.

### Evaluation Method

The soft magnetic alloys produced above were subjected to the following evaluations. The evaluations were performed at room temperature.

### (1) Check of Amorphization

The alloy ribbon before the heat treatment was subjected to X-ray diffraction to check whether the structure was amorphous. X-ray diffraction measurement was performed by radiating X-rays to a free surface (a surface not in contact with the roll during quenching) of the alloy ribbon before heat treatment. Cu Kα rays were used as an X-ray source. In the obtained diffraction patterns, the crystallinity (A_{cry}/Aₐₘₒ+A_{cry}) was calculated based on the integrated intensity (A_{cry}) of peaks derived from a crystalline phase (α phase) and integrated intensity (Aₐₘₒ) of peaks derived from an amorphous phase. In the case where the obtained crystallinity was less than 0.1, it was determined that the amorphization was sufficient (A). On the other hand, in the case where the crystallinity was 0.1 or more, it was determined that the amorphization was insufficient (B). Here, a peak corresponding to a (220) plane of the α phase was used as the peak derived from the crystalline phase, and a peak having a diffraction angle 2θ satisfying 30°≤2θ≤60° and a full width at half maximum ≥3° was used as the peak derived from the amorphous phase.

### (2) Check of Structure After Heat Treatment

The alloy ribbon after the heat treatment was subjected to X-ray diffraction measurement in the same manner as in the test of (1) above. The type of the formed structure was determined from the obtained X-ray diffraction pattern. In the case where a structure in which an amorphous structure and a body-centered cubic structure (α phase) of Fe coexist was obtained, it was determined that a suitable structure was formed (A). On the other hand, in the case where other structures were formed, it was determined that a suitable structure was not formed (B). In addition, in the sample which was actually determined as “B”, the FeB compound was generated in addition to the amorphous structure and the body-centered cubic structure of Fe.

### (3) Crystal Grain Size

In the X-ray diffraction pattern obtained in the test of (2) above, an average grain size of the crystal grains was calculated based on the width of the peak corresponding to a (110) plane of the α phase using the Scherrer equation below.

$$D = K λ / B cos θ$$

Here, D represents a crystal grain size. K represents a Scherrer constant, and was set to 0.9. λ represents the wavelength of the X-ray, B represents the width of the diffraction peak, and θ represents the Bragg angle.

### (4) Electrical Resistivity

The electrical resistivity of the alloy ribbon after the heat treatment was measured. Specifically, the electrical resistance of an alloy ribbon having a length of 100 mm or more was measured by a four-terminal method using an electric resistance measurement system for metals and semiconductors TER-2000RH (manufactured by ADVANCE RIKO, Inc.). The electrical resistivity was determined from the measured value and the cross-sectional area of the alloy ribbon. The cross-sectional area was calculated based on true density of the alloy ribbon measured by the Archimedes method and a distance between terminals.

### (5) ·Saturation Magnetic Flux Density

The saturation magnetic flux density of the toroidal wound core after the heat treatment was measured. Specifically, a B-H curve at the maximum magnetic field Hm=800 A/m was acquired using a DC magnetization property test device, and the value of the magnetic flux density at H=800 A/m was recorded as the saturation magnetic flux density Bs.

### Test Results

Table 1 shows the component compositions and the results of the evaluations for Examples 1 to 22 and Comparative Examples 1 to 10. In the component composition, the total amount of the element M([Co]+[Ni]+[Cr]+[Mn]) and the A value ((2 [Co]+1 [Ni])−(1 [Cr]+2 [Mn])) are also shown. In the table, regarding the element M, the column indicated by “-” means that the element M is not contained other than the unavoidable impurities, and the content of the unavoidable impurities is less than 0.01%. Regarding Mg and Ca, the total amount of Mg and Ca is shown. In the table, regarding evaluation results, the column indicated by “-” means that the result is not obtained.

TABLE 1

| | Element content [at %] | | | | | | | | | | | |
|---|---|---|---|---|---|---|---|---|---|---|---|---|
| | Element M | | | | | | | | | | | |
| Sample No. | Cr | | Mn | | Co | | Ni | | Total | | A value | |
| Example 1 | 1.5 | | — | | 0.5 | | — | | 2.0 | | −0.5 | |
| Example 2 | 0.5 | | — | | 0.5 | | — | | 1.0 | | 0.5 | |
| Example 3 | — | | 1.0 | | 1.0 | | — | | 2.0 | | 0.0 | |
| Example 4 | 1.0 | | — | | — | | 1.0 | | 2.0 | | 0.0 | |
| Example 5 | 1.5 | | — | | — | | 3.0 | | 4.5 | | 1.5 | |
| Example 6 | 2.5 | | — | | 1.5 | | — | | 4.0 | | 0.5 | |
| Example 7 | — | | 2.0 | | 1.0 | | — | | 3.0 | | −2.0 | |
| Example 8 | — | | 5.0 | | 5.0 | | — | | 10.0 | | 0.0 | |
| Example 9 | 5.0 | | — | | — | | 5.0 | | 10.0 | | 0.0 | |
| Example 10 | 1.0 | | — | | — | | 1.0 | | 2.0 | | 0.0 | |
| Example 11 | 1.0 | | — | | — | | 1.0 | | 2.0 | | 0.0 | |
| Example 12 | 1.0 | | — | | — | | 1.0 | | 2.0 | | 0.0 | |
| Example 13 | 1.0 | | — | | — | | 1.0 | | 2.0 | | 0.0 | |
| Example 14 | 1.0 | | — | | — | | 1.0 | | 2.0 | | 0.0 | |
| Example 15 | 1.0 | | — | | — | | 1.0 | | 2.0 | | 0.0 | |
| Example 16 | 1.0 | | — | | — | | 1.0 | | 2.0 | | 0.0 | |
| Example 17 | 1.0 | | — | | — | | 1.0 | | 2.0 | | 0.0 | |
| Example 18 | 1.0 | | — | | — | | 1.0 | | 2.0 | | 0.0 | |
| Example 19 | 1.0 | | — | | — | | 1.0 | | 2.0 | | 0.0 | |
| Example 20 | 1.0 | | — | | — | | 1.0 | | 2.0 | | 0.0 | |
| Example 21 | 1.0 | | — | | — | | 1.0 | | 2.0 | | 0.0 | |
| Example 22 | 1.0 | | — | | — | | 1.0 | | 2.0 | | 0.0 | |
| Comparative Example 1 | — | | — | | — | | — | | 0.0 | | 0.0 | |
| Comparative Example 2 | 0.1 | | — | | 0.1 | | — | | 0.2 | | 0.1 | |
| Comparative Example 3 | 1.0 | | — | | — | | 1.0 | | 2.0 | | 0.0 | |
| Comparative Example 4 | 1.0 | | — | | — | | 1.0 | | 2.0 | | 0.0 | |
| Comparative Example 5 | 1.0 | | — | | — | | 1.0 | | 2.0 | | 0.0 | |
| Comparative Example 6 | 1.0 | | — | | — | | 1.0 | | 2.0 | | 0.0 | |
| Comparative Example 7 | 1.0 | | — | | — | | 1.0 | | 2.0 | | 0.0 | |
| Comparative Example 8 | 6.0 | | — | | — | | 7.0 | | 13.0 | | 1.0 | |
| Comparative Example 9 | — | | 2.5 | | — | | 1.0 | | 3.5 | | −4.0 | |
| Comparative Example 10 | 1.0 | | — | | 2.5 | | — | | 3.5 | | 4.0 | |
| | Element content [at %] | | | | | | | | | | | |
| Sample No. | Si | B | Nb | Cu | P | S | Al | Mo | C | O | N | Mg, Ca |
| Example 1 | 16.2 | 8.3 | 3.0 | 0.9 | <0.01 | <0.01 | <0.02 | <0.02 | 0.0048 | <0.03 | <0.03 | <0.03 |
| Example 2 | 16.3 | 8.4 | 3.0 | 1.0 | <0.01 | <0.01 | <0.02 | <0.02 | 0.0047 | <0.03 | <0.03 | <0.03 |
| Example 3 | 16.2 | 8.1 | 3.1 | 1.0 | <0.01 | <0.01 | <0.02 | <0.02 | 0.0041 | <0.03 | <0.03 | <0.03 |
| Example 4 | 15.8 | 8.3 | 2.8 | 1.0 | <0.01 | <0.01 | <0.02 | <0.02 | 0.0048 | <0.03 | <0.03 | <0.03 |
| Example 5 | 16.4 | 8.2 | 3.0 | 1.1 | <0.01 | <0.01 | <0.02 | <0.02 | 0.0046 | <0.03 | <0.03 | <0.03 |
| Example 6 | 16.2 | 8.1 | 3.0 | 1.0 | <0.01 | <0.01 | <0.02 | <0.02 | 0.0047 | <0.03 | <0.03 | <0.03 |
| Example 7 | 16.8 | 7.9 | 2.5 | 1.1 | <0.01 | <0.01 | <0.02 | <0.02 | 0.0042 | <0.03 | <0.03 | <0.03 |
| Example 8 | 15.5 | 8.2 | 3.1 | 0.9 | <0.01 | <0.01 | <0.02 | <0.02 | 0.0045 | <0.03 | <0.03 | <0.03 |
| Example 9 | 15.8 | 8.0 | 3.0 | 1.0 | <0.01 | <0.01 | <0.02 | <0.02 | 0.0046 | <0.03 | <0.03 | <0.03 |
| Example 10 | 7.1 | 10.0 | 2.9 | 1.1 | <0.01 | <0.01 | <0.02 | <0.02 | 0.005 | <0.03 | <0.03 | <0.03 |
| Example 11 | 13.5 | 6.1 | 3.3 | 1.0 | <0.01 | <0.01 | <0.02 | <0.02 | 0.0047 | <0.03 | <0.03 | <0.03 |
| Example 12 | 19.8 | 5.2 | 2.8 | 1.0 | <0.01 | <0.01 | <0.02 | <0.02 | 0.0048 | <0.03 | <0.03 | <0.03 |
| Example 13 | 16.4 | 5.0 | 3.0 | 2.0 | <0.01 | <0.01 | <0.02 | <0.02 | 0.0041 | <0.03 | <0.03 | <0.03 |
| Example 14 | 16.2 | 8.0 | 2.8 | 1.0 | <0.01 | <0.01 | <0.02 | <0.02 | 0.0043 | <0.03 | <0.03 | <0.03 |
| Example 15 | 12.1 | 10.0 | 3.0 | 1.1 | <0.01 | <0.01 | <0.02 | <0.02 | 0.005 | <0.03 | <0.03 | <0.03 |
| Example 16 | 16.2 | 8.1 | 4.1 | 1.2 | <0.01 | <0.01 | <0.02 | <0.02 | 0.005 | <0.03 | <0.03 | <0.03 |
| Example 17 | 15.8 | 7.2 | 4.9 | 0.8 | <0.01 | <0.01 | <0.02 | <0.02 | 0.0044 | <0.03 | <0.03 | <0.03 |
| Example 18 | 15.8 | 7.2 | 4.9 | 0.8 | <0.01 | <0.01 | <0.02 | 2.0 | 0.060 | <0.03 | <0.03 | <0.03 |
| Example 19 | 16.4 | 8.1 | 2.8 | 0.6 | <0.01 | <0.01 | <0.02 | <0.02 | 0.0041 | <0.03 | <0.03 | <0.03 |
| Example 20 | 16.2 | 8.0 | 3.2 | 2.0 | <0.01 | <0.01 | <0.02 | <0.02 | 0.0041 | <0.03 | <0.03 | <0.03 |
| Example 21 | 16.3 | 8.4 | 2.9 | 1.1 | 0.10 | <0.01 | <0.02 | <0.02 | 0.0048 | <0.03 | <0.03 | <0.03 |
| Example 22 | 16.4 | 8.3 | 2.8 | 1.0 | <0.01 | 0.10 | <0.02 | <0.02 | 0.0044 | <0.03 | <0.03 | <0.03 |
| Comparative | 16.2 | 9.0 | 3.0 | 1.1 | <0.01 | <0.01 | <0.02 | <0.02 | 0.0048 | <0.03 | <0.03 | <0.03 |
| Example 1 | | | | | | | | | | | | |
| Comparative | 16.2 | 8.3 | 3.0 | 0.9 | <0.01 | <0.01 | <0.02 | <0.02 | 0.0044 | <0.03 | <0.03 | <0.03 |
| Example 2 | | | | | | | | | | | | |
| Comparative | 3.0 | 8.3 | 2.9 | 1.1 | <0.01 | <0.01 | <0.02 | <0.02 | 0.0042 | <0.03 | <0.03 | <0.03 |
| Example 3 | | | | | | | | | | | | |
| Comparative | 21.0 | 4.0 | 2.9 | 1.1 | <0.01 | <0.01 | <0.02 | <0.02 | 0.0044 | <0.03 | <0.03 | <0.03 |
| Example 4 | | | | | | | | | | | | |
| Comparative | 16.3 | 8.8 | 1.8 | 1.2 | <0.01 | <0.01 | <0.02 | <0.02 | 0.004 | <0.03 | <0.03 | <0.03 |
| Example 5 | | | | | | | | | | | | |
| Comparative | 15.4 | 9.7 | 5.6 | 0.9 | <0.01 | <0.01 | <0.02 | <0.02 | 0.0042 | <0.03 | <0.03 | <0.03 |
| Example 6 | | | | | | | | | | | | |
| Comparative | 16.0 | 8.6 | 3.1 | 3.0 | <0.01 | <0.01 | <0.02 | <0.02 | 0.0044 | <0.03 | <0.03 | <0.03 |
| Example 7 | | | | | | | | | | | | |
| Comparative | 15.8 | 8.0 | 3.0 | 1.0 | <0.01 | <0.01 | <0.02 | <0.02 | 0.0043 | <0.03 | <0.03 | <0.03 |
| Example 8 | | | | | | | | | | | | |
| Comparative | 16.2 | 8.1 | 2.9 | 0.9 | <0.01 | <0.01 | <0.02 | <0.02 | 0.0047 | <0.03 | <0.03 | <0.03 |
| Example 9 | | | | | | | | | | | | |
| Comparative | 16.2 | 7.9 | 3.3 | 0.9 | <0.01 | <0.01 | <0.02 | <0.02 | 0.0044 | <0.03 | <0.03 | <0.03 |
| Example 10 | | | | | | | | | | | | |

| | Evaluation results | | | | |
|---|---|---|---|---|---|
| | | Structure | | | |
| | | after heat | | Electrical | Saturation |
| | | treat- | Crystal grain | resistivity | magnetic flux |
| Sample No. | Amorphization | ment | size [nm] | [μΩm] | density [T] |
| Example 1 | A | A | 13.1 | 107 | 1.10 |
| Example 2 | A | A | 13.1 | 114 | 1.23 |
| Example 3 | A | A | 13.2 | 122 | 1.10 |
| Example 4 | A | A | 13.3 | 126 | 1.24 |
| Example 5 | A | A | 13.3 | 141 | 1.26 |
| Example 6 | A | A | 13.4 | 152 | 1.18 |
| Example 7 | A | A | 13.3 | 136 | 1.12 |
| Example 8 | A | A | 13.4 | 155 | 1.13 |
| Example 9 | A | A | 13.3 | 156 | 1.18 |
| Example 10 | A | A | 13.6 | 122 | 1.22 |
| Example 11 | A | A | 12.5 | 130 | 1.21 |
| Example 12 | A | A | 13.3 | 120 | 1.15 |
| Example 13 | A | A | 13.3 | 123 | 1.21 |
| Example 14 | A | A | 13.5 | 110 | 1.17 |
| Example 15 | A | A | 13.1 | 120 | 1.23 |
| Example 16 | A | A | 13.1 | 110 | 1.10 |
| Example 17 | A | A | 13.3 | 121 | 1.18 |
| Example 18 | A | A | 12.9 | 122 | 1.18 |
| Example 19 | A | A | 12.5 | 118 | 1.19 |
| Example 20 | A | A | 15.6 | 127 | 1.16 |
| Example 21 | A | A | 13.5 | 126 | 1.20 |
| Example 22 | A | A | 13.2 | 127 | 1.21 |
| Comparative Example 1 | A | A | 13.4 | 104 | 1.14 |
| Comparative Example 2 | A | A | 13.1 | 106 | 1.23 |
| Comparative Example 3 | A | B | 21.1 | 121 | 1.30 |
| Comparative Example 4 | B | A | — | — | — |
| Comparative Example 5 | A | A | 33.0 | 102 | 1.16 |
| Comparative Example 6 | A | A | 9.1 | 106 | 0.81 |
| Comparative Example 7 | A | A | 35.0 | 104 | 1.15 |
| Comparative Example 8 | A | A | 21.0 | 143 | 0.71 |
| Comparative Example 9 | A | A | 13.3 | 123 | 0.61 |
| Comparative Example 10 | A | A | 13.2 | 122 | 0.50 |

In Table 1, the soft magnetic alloys of Examples 1 to 22 contain 0.9%<M ≤10%, 5 7.0%≤Si≤20%, 5.0%≤B≤10%, 2.5%≤Nb≤5.0%, and 0.5%≤Cu≤2.0%, with the balance being Fe and unavoidable impurities. The A value is in the range of −3.0% <A <3.0%. Correspondingly, in any soft magnetic alloy of Example, the alloy ribbon before the heat treatment is amorphized, and the amorphous structure and the body-centered cubic structure of Fe coexist through the heat treatment to obtain a nanocrystal alloy having an 10 average crystal grain size of 30 nm or less. In addition, an electrical resistivity of 107 μm or more and a saturation magnetic flux density of 1.10 T or more are obtained, and both high electrical resistance and high saturation magnetic flux density are achieved.

In Comparative Example 1, the element M was not added. In Comparative Example 2, the element M was added, but the total amount was too small. Correspondingly, in Comparative Examples 1 and 2, the electrical resistivity is lower than 107 μΩm. On the other hand, in Comparative Example 8, the addition amount of the element M is too large, and correspondingly, the saturation magnetic flux density is significantly lower than 1.10 T. In Comparative Examples 9 and 10, the total content of the element M is in the range of 0.9%<M≤10%, but the A value is outside the range of −3.0%<A<3.0%. Correspondingly, the saturation magnetic flux density is significantly lower than 1.10 T. From the comparison between Comparative Examples and Examples, it is understood that in order to achieve both a high electrical resistance and a high saturation magnetic flux density in the soft magnetic alloy, it is necessary to maintain the balance of the contents of Cr, Mn, Co, and Ni so that the total amount of the element M, that is, at least one selected from the group consisting of Cr, Mn, Co, and Ni is in an appropriate range, and the degree of change in the number of valence electrons from a state where Fe is not substituted with the element M, which is represented by the A value, is sufficiently reduced.

In Comparative Example 3, the content of Si does not satisfy the above range. In Comparative Example 4, the contents of Si and B do not satisfy the above ranges. Correspondingly, the soft magnetic alloys in the comparative examples 3 and 4 are not alloys which are configured to give a nanocrystal alloy obtained by performing heat treatment on an amorphous alloy ribbon. Further, in Comparative Example 3, FeB is generated after the heat treatment, and it is considered that this is because the crystallization temperature of the FeB compound is lowered when the content of Fe is relatively large. In Comparative Example 4, corresponding to the fact that the content of B which contributes to amorphization of the soft magnetic alloy is too small, the amorphization is insufficient. In Comparative Example 5, corresponding to the fact that the content of Nb is too small, the coarsening of the crystal grains cannot be sufficiently prevented, and the average crystal grain size after the heat treatment exceeds 30 nm. On the other hand, in Comparative Example 6, corresponding to the fact that the content of Nb is too large, the saturation magnetic flux density is significantly lower than 1.10 T. In Comparative Example 7, corresponding to the fact that the content of Cu is too large, as in Comparative Example 5, the coarsening of crystal grains cannot be sufficiently prevented, and the average crystal grain size after the heat treatment exceeds 30 nm. In Comparative Examples 5 to 7, the electrical resistivity is also lower than 107 μΩm.

The embodiments and Examples of the present invention have been described above. The present invention is not particularly limited to these embodiments and Examples, and various modifications may be made.

The present application is based on Japanese Patent Application No. 2024-051697 filed on Mar. 27, 2024, and the contents thereof are incorporated herein by reference.

What is claimed is:

1. A soft magnetic alloy comprising, in terms of at %:
9%<M≤10%, M being at least one element selected from the group consisting 5 of Cr, Mn, Ni, and Co;
$$7. \% \leq Si \leq 20 \% ;$$
$$5. \% \leq B \leq 10 \% ;$$
$$2.5 \% \leq N b \leq 5. \% ;$$
$$0.5 \% \leq Cu \leq 2. \% ,$$
with the balance being Fe and unavoidable impurities,
wherein the soft magnetic alloy satisfies −3.0%<(2 [Co]+1 [Ni])−(1 [Cr]+2 [Mn])<3.0%, in which [Co], [Ni], [Cr], and [Mn] respectively represents contents of Co, Ni, Cr, and Mn.

2. The soft magnetic alloy according to claim 1, further comprising, in terms of at %:
at least one of 0%<P≤2.0% or 0%<S≤0.15%.

3. The soft magnetic alloy according to claim 1, wherein the soft magnetic alloy is in a form of an amorphous alloy ribbon.

4. The soft magnetic alloy according to claim 2, wherein the soft magnetic alloy is in a form of an amorphous alloy ribbon.

5. The soft magnetic alloy according to claim 3, which is configured to generate nanocrystals having an average grain size of 30 nm or less through a heat treatment at 570° C. for 30 minutes.

6. The soft magnetic alloy according to claim 4, which is configured to generate nanocrystals having an average grain size of 30 nm or less through a heat treatment at 570° C. 30 for 30 minutes.

7. The soft magnetic alloy according to claim 1, wherein the soft magnetic alloy is in a form of an alloy ribbon containing nanocrystals.

8. The soft magnetic alloy according to claim 2, wherein the soft magnetic alloy is in a form of an alloy ribbon containing nanocrystals.

9. The soft magnetic alloy according to claim 7, wherein the nanocrystals have an average grain size of 30 nm or less.

10. The soft magnetic alloy according to claim 8, wherein the nanocrystals have an average grain size of 30 nm or less.
